(19) United States
(12) Patent Application Publication
(10) Pub. No.: US 2025/0319549 A1
(43) Pub. Date: Oct. 16, 2025

(54) METHOD AND SYSTEM FOR WELDING BATTERY MODULES

(71) Applicant: LASERAX INC., Québec (CA)

(72) Inventors: Alex FRASER, St-Michel-de-Bellechasse (CA); Karl FAHLSTROM, Stockholm (SE)

(21) Appl. No.: 19/055,886

(22) Filed: Feb. 18, 2025

Related U.S. Application Data
(60) Provisional application No. 63/557,087, filed on Feb. 23, 2024.

(51) Int. Cl. B23K 26/24; B23K 26/082; H01M 50/213; H01M 50/516

(52) U.S. Cl. CPC B23K 26/24; B23K 26/082; H01M 50/213; H01M 50/516

(57) ABSTRACT

A method for laser-welding a busbar to battery cells with a laser-welding system having a laser scanning head, the busbar having a first and second tabs, the battery cells having first and second poles. The first pole is welded to the first tab along a first welding path segment while the first pole and the first tab are clamped, with an extent of the first welding path segment being limited to limit a temperature at the first pole. Subsequently to said welding along the first welding path segment, the second pole is welded to the second tab along a second welding path segment while the second pole and the second tab are clamped, thereby allowing the temperature at the first pole to decrease. Subsequently to said allowing the temperature at the first pole to decrease, the first pole is welded to the first tab along a third welding path segment.

### TECHNICAL FIELD

This disclosure generally relates to energy storing systems and more specifically to the assembly of a battery module.

### BACKGROUND

Typically, energy storing systems include one or more packs of multiple battery modules, with each battery module containing a number of battery cells held in an arrayed configuration relative one another (i.e., stacked), and a busbar connecting the battery cells in an electrical circuit. Among the existing various types of battery cells used in battery modules, cylindrical geometries are amongst the most widely used. In some markets, such as electrical vehicles for instance, a widely used format has cylindrical geometries with both the positive pole and the negative pole accessible at the same end, which can be referred to as the pole end. Such as shown in the example presented in FIGS. 1, 1A and 1B, the battery cells can be stacked with the axes of the battery cells parallel to one another, the pole ends all facing the same side, and the pole ends are aligned within a common pole plane extending normal to the axes.

A component typically referred to as a busbar can be used to connect the battery cells, and more specifically the battery poles, in the electrical circuit. The busbar can be provided in the form of a sheet-like element having independent conductive paths with positive and negative pole regions, also referred to as tabs. The busbar can be aligned parallel to the common pole plane and positioned adjacent the poles of the battery cells, with the tabs of the busbar welded to corresponding ones of the poles.

The busbar and the battery cells are manufactured individually from one another and assembled to one another by a welding step. The welding step involves as many independent welds as there are tabs/poles to be welded. Moreover, the battery cells are typically at least partially charged during the welding operation, since for many battery types, leaving a battery uncharged for extended periods of time may render it inoperable. Henceforth, the welding operation may involve positioning the stacked battery cells in a welding area of a welding system, with the poles facing upwardly and the busbar extending above the poles, with the tabs vertically aligned with corresponding ones of the poles, and welding pole/tab pairs to one another one by one until all the poles are welded to corresponding tabs of the busbar, into a battery module configuration.

Although existing welding techniques were satisfactory to a certain degree, there always remained room for improvement.

### SUMMARY

In the context of migrating an increasing portion of energy consumption from fossil fuel energy towards electrical energy, manufacturing energy storing systems as efficiently as possible is desirable, which can involve different aspects.

In accordance with one aspect, there is provided a method for laser-welding a busbar to a plurality of battery cells with a laser-welding system having a laser scanning head, the busbar having a first tab and a second tab, the plurality of battery cells having a first pole and a second pole, the method comprising: welding the first pole to the first tab along a first welding path segment while the first pole and the first tab are clamped, including limiting an extent of the first welding path segment to limit a temperature at the first pole; subsequently to said welding along the first welding path segment, welding the second pole to the second tab along a second welding path segment while the second pole and the second tab are clamped, thereby allowing the temperature at the first pole to decrease; and subsequently to said allowing the temperature at the first pole to decrease, welding the first pole to the first tab along a third welding path segment.

In accordance with another aspect, there is provided a battery module having a plurality of battery cells, each battery cell of the plurality of battery cells having a first pole and a second pole, and a busbar having a plurality of tabs welded to corresponding ones of the first poles and second poles, the plurality of tabs being welded to corresponding ones of the first poles along a first weld pattern, the plurality of tabs being welded to corresponding ones of the second poles along a second weld pattern, the second weld pattern having a second weld segment, the first weld pattern having a first weld segment, a third weld segment, and a discontinuity between the first weld segment and the third weld segment.

Many further features and combinations thereof concerning the present improvements will appear to those skilled in the art following a reading of the instant disclosure.

### BRIEF DESCRIPTION OF THE DRAWINGS

FIG. 1 is an oblique view of an example of a busbar, in accordance with the prior art;

FIG. 1A is a sectional view of the busbar of FIG. 1, taken along section 1A-1A, showing an underlying battery module, in accordance with the prior art;

FIG. 1B is a top view of a portion of the busbar of FIG. 1, showing the underlying battery module and weld lines, in accordance with the prior art;

FIG. 2 is a schematic view of an example of a system for laser-welding a busbar to a battery module, shown with a laser-welding system and a robot arm having an end effector, in accordance with one or more embodiments;

FIG. 3 is a side view of the end effector of FIG. 2, in accordance with one or more embodiments;

FIG. 3A is a partial top view of the end effector of FIG. 2, in accordance with one or more embodiments;

FIG. 4 is a graph showing states for the laser-welding system and robot arm of FIG. 2 during two consecutive welding sequences, in accordance with one or more embodiments;

FIG. 5 is a graph showing states for another laser-welding system with multiple robot arms of the system during consecutive welding sequences, in accordance with one or more embodiments;

FIGS. 6A-6C are perspective, top and enhanced top views of a battery cell to be welded by a laser-welding system, in accordance with one or more embodiments;

FIGS. 7A-7D are enhanced top views of a battery cell to be welded by a laser-welding system, in accordance with one or more embodiments;

FIG. 8 is an example of a flow chart of a method for laser-welding a busbar to a battery module, in accordance with one or more embodiments;

FIG. 9 is an example of a flow chart of another method for laser-welding a busbar to a battery module, in accordance with one or more embodiments; and

FIG. 10 is a schematic view of an example of a computing device of a controller of a system for laser-welding a busbar to a battery module, in accordance with one or more embodiments.

### DETAILED DESCRIPTION

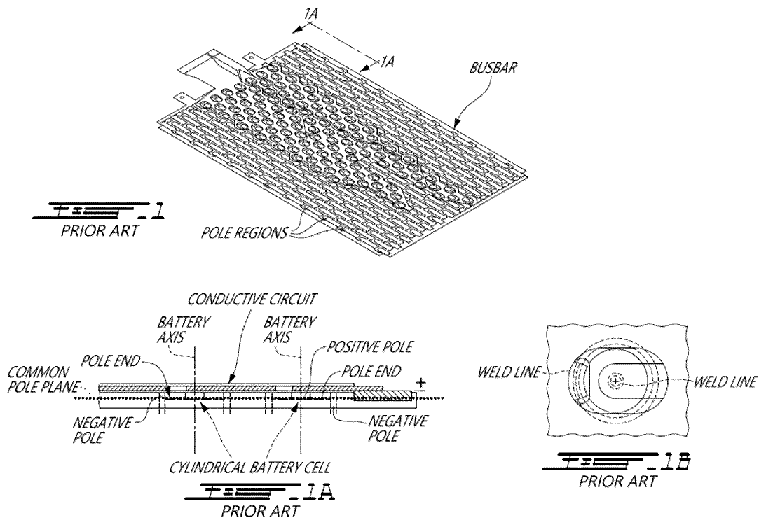

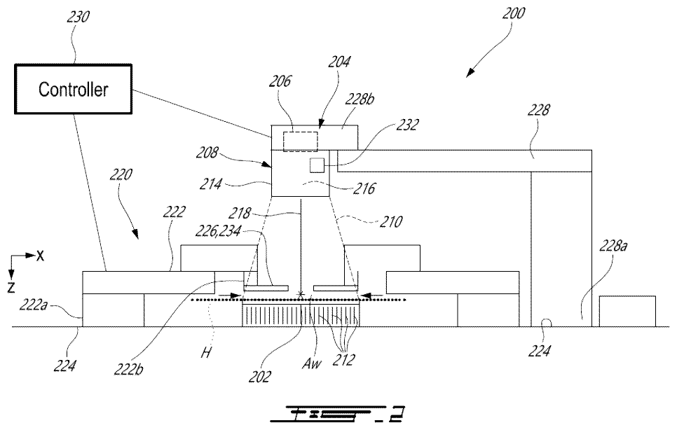

FIGS. 1 and 1A show an example of an energy storing device having a busbar which is to be welded to battery cells to form a battery module. In this example, the busbar is provided in the form of a sheet-like element having sets of pole regions or tabs interconnected via conductive paths. Typically, such a busbar can have a plurality of negative tabs interconnected to one another via a negative conductive path, and a plurality of positive tabs interconnected to one another via a positive conductive path, for example. The busbar can be deposited onto the arrayed battery cells in a manner aligning all the tabs of the busbar to corresponding electrical poles of the battery cells (see FIG. 1A). The battery module includes a number of battery cells which are, in this example, of cylindrical shape. As depicted, the battery cells have both electrical poles accessible at a same, upper end. More specifically, each battery cell has an upper end with a first electric pole, which is provided here in the form of a protrusion located on the centre of one of the disk-shaped endface of the cell, and a second electric pole, provided here as an end of a peripheral wall extending between a first, upper end of the battery cell to an opposite second, lower end. In this example, the first electric pole is a positive pole, and the second electric pole is a negative pole. As shown, the busbar has at least a pair of positive and negative tabs positioned over a corresponding pair of electrical poles of the battery module when the busbar is suitably positioned over the battery module. The poles can be reversed, and their respective shape, form or size changed depending on the embodiment. The battery cells showed in this example are standardized battery cell “size 21700,” however any other battery cell type can be used in other embodiments such as standardized battery cell “size 18650” to name another example. FIG. 1B shows a top view of the busbar showing the underlying battery cell in dashed lines. As shown, example first and second weld lines for the positive and negative poles are also shown in dashed lines.

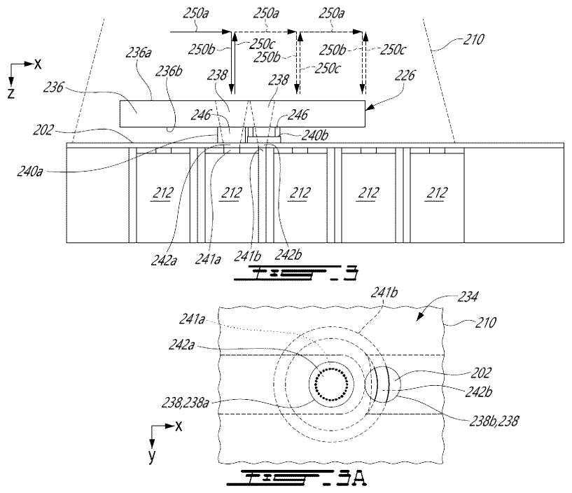

FIG. 2 shows an example of a laser welding system 200 for laser-welding a busbar 202. As shown, the laser welding system 200 has a laser welder 204 having a laser emitter 206 optically coupled to scanning head 208 with a field of view 210 encompassing at least a portion of the welding area A_{w}. In this example, the busbar 202 is aligned with a horizontal plane H. The scanning head 208 is positioned directly over the busbar 202 and oriented downwardly towards the busbar 202. However, while positioning the scanning head 208 above the busbar 202 can be preferred in some embodiments, in other embodiments the field of view 210 may be oriented obliquely relative to the busbar 202. The field of view 210 of the scanning head 208 encompasses a significant number of battery cells 212 such as more than twenty-five battery cells or more than one hundred battery cells. The scanning head 208 can include an enclosure 214 and a beam delivery output 216 positioned within the enclosure 214 and delivering a laser beam 218 when desired. Adjustable mirror assemblies can be included the scanning head 208 to receive the laser beam 218 and move the laser beam 218 anywhere within the plane of the busbar 202, i.e., along the x- and y-axes. In some embodiments, the scanning head 208 can have an adjustable focal lens allowing a focal point of the laser beam to be moved along the z-axis. For instance, the adjustable mirror assemblies can include one or more 1-, 2- or 3-axes mirror galvanometer scanning heads and/or any other suitable optical component. As a result, the construction of the scanning head 208 can differ from one embodiment to another. In this embodiment, the busbar 202 is positioned within the field of view 210 of the scanning head 208 and at a distance within a working distance of the scanning head 208. Accordingly, the scanning head 208 needs not to be moved to laser-weld different portions of the busbar 202, the laser beam 218 is moved simply by the movement of the mirrors within the scanning head 208. The working distance of the scanning head 208 can range between 10 and 100 cm, between 25 and 75 cm or around 55 cm for example.

The laser welding system 200 has a robot 220 having first robot arm 222 having a first end 222a fixed to a base 224 and a second end 222b bearing the end effector 226 and movable within the field of view 210 of the scanning head 208. The base 224 can be a table or the ground of a manufacturing facility, depending on the embodiment. The first robot arm 222 can be any suitable type of manufacturing or industrial robot arm such as a delta robot arm, a SCARA robot arm, and the like. As shown, the first robot arm 222 can be operated independently of the operation of the scanning head 208, and can be moved independently of the activation or movement of the laser beam 218. Accordingly, the first robot arm 222 can be moved within the field of view 210 of the scanning head 208 as desired. In some embodiments, the laser welding system 200 can be provided with a second robot arm 228 having a first end 228a fixed to the same base 224 or a different base, and a second end 228b holding the scanning head 208 for movement thereof. As shown, the scanning head 208 can be moved in a plane parallel to the plane of the busbar 202 independently from the second end 222b of the first robot arm 222 as the first and second robot arms 222 and 228 are independent from one another. In other embodiments, the second robot arm 228 can be substituted for a gantry system having a holder holding the scanning head 208 and moving the scanning head 208 into the x-y plane, above the stack of battery cells 212.

The laser welding system 200 can include a controller 230 communicatively coupled to the laser-welding system 200, the first robot arm 222, the second robot arm 228, or a combination thereof. The controller 230 generally has a processor and a memory having stored thereon instructions that when executed perform steps of performing one or more laser-welding sequences including, but not limited to, i) moving the first and second robot arms 222 and 228 in a coordinated sequence of movement, ii) changing the orientation of the laser beam 218 using the scanning head 208, and iii) activating and deactivating the laser welder 204 when necessary. In some embodiments, the laser welding system 200 can have a camera 232 communicatively coupled to the controller 230. The camera 232 can be configured for acquiring one or more two-or three-dimensional images of the busbar 202. The controller 230 can then receive the image(s) and determine a position and an orientation for each one of the pair(s) of tabs of the busbar 202 which can then be used for laser-welding sequence. In some embodiments, the position and orientation of the tabs of the busbar 202 is determined at a modeling station spaced apart from the laser-welding station. For instance, a three-dimensional model of the battery module and its busbar can be made at the modeling station. In these embodiments, the camera 232 can be used to detect the position of one or more fiducials on the battery module(s) which can help the positioning of the three-dimensional model within a coordinate system of the laser welding system 200.

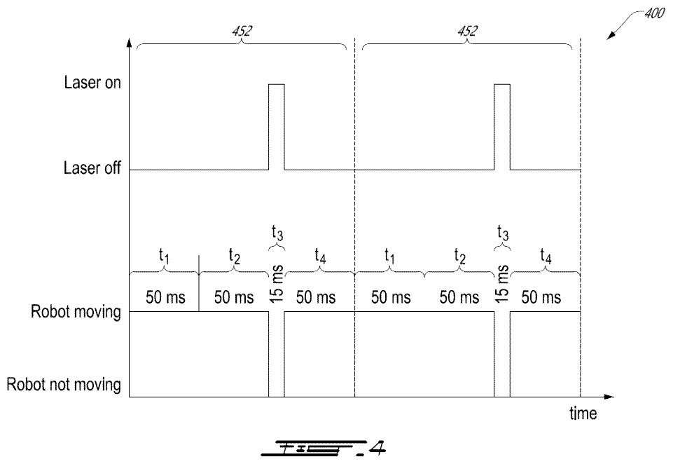

In this embodiment, the end effector(s) 226 of the robot 220 can be embodied as a pressure applicator 234. In this embodiment, as best shown in FIG. 3, the end effector 226 has a body 236 with a first face 236a facing the scanning head, and an opposite, second face 236b facing the busbar 202. The body 236 of the end effector 226 also has one or more openings forming at least one laser aperture 238 extending across the body 236 from the first face 236a to the second face 236b. The end effector 226 can have one or more portions configured for being in contact with the busbar 202 during application of the pressure to the tabs, and such portions can be referred to as “clamping elements 240”. Each clamping element 240a, 240b typically has a certain surface area which is configured to partially or fully surround the tabs, with a view of balancing out the pressure, and can thus be said to have a plurality of pressure points surrounding the laser aperture 238. One or more tabs can thus be clamped at a given time. The end effector 226 can have a weight below 5000 grams, preferably below 1000 grams and more preferably below 500 grams. By limiting the weight of the end effector 226, its resistance to movement or inertia is limited which can in turn allow faster end effector displacements. The end effector 226 can be moved by the second end of the first robot arm at a maximal speed of at least 5 m/s, preferably at least 8 m/s and more preferably at least 12 m/s. In some embodiments, the time required for an instance of the laser-welding sequence is below 500 ms, preferably below 300 ms and more preferably below 200 ms, for example.

In an embodiment where the positive and negative poles 241a and 241b of the battery cells 212 are both accessible on the same face of the battery array, it can be convenient for the end effector 226 to have both a positive, first clamping element 240a and a negative, second clamping element 240b, each having an associated laser aperture 238, through which a corresponding one of the positive tab 242a and or the negative tab 242b of the busbar 202 can be welded sequentially (i.e., without moving the end effector 226 therebetween), or simultaneously (i.e., if there is more than one laser beam).

In some embodiments, it can be preferred for a clamping element to be received by the body 236 of the end effector 226 via a resilient member 246, as this can allow some greater flexibility to adapt to relatively minor variations in height from one tab to the next, for instance, and to facilitate the application of a generally uniform pressure from one tab to the next along the welding path. Moreover, in some embodiments, it can be preferred for a clamping element to be a distinct component assembled to the resilient member, as opposed to being embodied simply as a portion of the clamping element. This can allow the clamping element and the resilient member to be made of different materials, for instance, or simply to be manufactured separately.

It will be noted that in some embodiments, a minimal charge may be required to remain in the battery cells at all time, in order to preserve the functionality of the battery cells. Accordingly, electrical energy may reside in the battery cells during the welding operation. In some embodiments, and especially in embodiments where a positive clamping element 240aand a negative clamping element 240b are both included in the end effector 226, it can be desired to electrically insulate the end effector 226 generally, or one or both positive and negative clamping elements 240a and 240b, from the remainder of the mechanical assembly. It can be relevant, for instance, to electrically insulate the positive clamping element 240a from the negative clamping element 240b to avoid a short circuit therebetween. Accordingly, in one embodiment, it can be desired for either one, or preferably both of the clamping elements 240a and 240b, to be electrically insulating. In one embodiment, this may be achieved by making the clamping elements 240 out of a material which is inherently electrically insulating, such as a plastic, or a ceramic material for instance. In another embodiment, this may be achieved by coating an inherently electrically conductive material, such as a metal, with an electrically insulating coating. In the context of this specification, a material can be considered electrically conductive if it has a conductivity of more than 10² S/m, preferably more than 10⁵ S/m whereas a material can be considered electrically insulating if it has a conductivity below 10⁻³ S/m, preferably below 10⁻¹ S/m.

Moreover, it will also be noted that in some embodiments, the laser activity can generate a significant amount of heat and therefore, it can be desired i) for one or more clamping elements 240a and 240b, and possibly also for one or more resilient members 246 to be thermally resistant, i.e., to be adapted to resist to the potentially high temperatures which can be expected during the laser welding process, and ii) for one or more clamping elements 240a and 240b to play a role of thermal insulation from the remainder of the mechanical assembly. Indeed, the clamping elements 240a and 240b can be relatively close to the area being subjected to welding, and thermally conductive metal of the busbar 202 may directly extend therebetween, leading to high temperatures at the clamping points. Accordingly, it can be desired for the clamping elements 240a and 240b to be not only made of an electrically insulating material, but further of a material which is thermally insulating, and potentially also resistant to relatively high temperatures. In some embodiments, a ceramic material or high temperature plastics can be particularly interesting in the circumstances. In the context of this specification, a material can be considered thermally conductive if it has a thermal conductivity of more than 1 W·m⁻¹·K⁻¹, preferably more than 100 1 W·m⁻¹·K⁻¹, and thermally insulating if it has a thermal conductivity of less than 1 W·m⁻¹·K⁻¹, preferably less than 0.1 W·m⁻¹·K⁻¹. In this specification, a material can be considered to be thermally resistant if it preserves its mechanical and structural properties at temperatures above 300° F., preferably above 500° F.

The welding process for assembling a battery module can consist of a series of welding steps, where a different welding path segment is performed at each one of the steps. A welding path segment typically extends along a line which can be straight or curvilinear, and which will be considered continuous by definition herein. An instance of the welding sequence, in one embodiment, generally includes a step of moving the end effector 226 within the field of view 210 of the scanning head to expose a positive and/or negative tab 242a and 242b of the busbar 202 to the scanning head through the laser apertures 238, such as shown in FIG. 3A, clamping the positive and/or negative tab 242a, 242b to a corresponding positive and/or negative pole of one (or more) battery cell, and directing the laser beam orientation to the corresponding positive and/or negative tabs 242a and 242b. Indeed, when the end effector 226 has reached the corresponding tab, it can be controlled to apply a force, e.g., via the clamping elements, to clamp the tabs of the busbar 202 against the positive and/or negative poles of a corresponding battery cell. While the end effector 226 is maintained in position, the laser-welding system is activated to laser weld the corresponding tab of the busbar 202 to a corresponding electrical pole of the battery cell through the laser aperture 238. The laser-welding sequence can be repeated for a sequence of battery cells to result in first and second weld lines, one for each of the pair of positive and negative tabs 242a and 242b of the busbar 202.

As shown in FIG. 3A, the laser aperture 238 can include first and second laser apertures 238a and 238b each sized and shaped to expose a corresponding one of the positive and negative tabs 242a and 242b of the pair. For instance, the first laser aperture 238a is sized and shaped to expose the positive tab 242a being above the positive pole 241a of the battery cell 212 whereas the second laser aperture 238b is sized and shaped to expose the negative tab 242b being above the negative pole 241b of the battery cell 212. In some embodiments, it can be preferred for the second laser aperture 238b to conform better in shape to the shape of the negative pole 241b, such as being elongated and somewhat arc-shaped, for instance. Referring back to FIG. 3, it was found convenient in some embodiments to have the laser aperture, e.g., the first and/or second laser apertures 238a and 238b, with taper shapes decreasing in diameter from the first face 236a to the second face 236b of the end effector 226. In this way, the tabs 242a and 242b of the busbar 202 can be exposed to the field of view 210 of the scanning head at greater angles. In some other embodiments, the body 236 of the end effector 226 has a thickness below a certain threshold, thereby allowing exposition at greater angles as well. For instance, in one embodiment, the body 236 of the end effector 226 can be flat and have a ranging between 1 and 20 mm, preferably between 2 and 10 mm and more preferably around 5 mm. In other embodiments, the body 236 can have different shapes.

As shown in FIG. 3, an instance of the welding sequence can include: a transversal movement 250a within a plane parallel to a plane of the busbar 202, via which the end effector 226 is moved into along the X-Y plane (e.g., horizontal) alignment with a given battery cell 212; a vertically downwards movement 250b, which can lead to the application of pressure; a period of immobility time during which the laser-welding is performed (the laser, directed to the corresponding region, is activated); and a vertically upwards movement 250c in which the end effector 226 is moved away from the busbar 202 after the laser-welding, including a relief of pressure. In an embodiment having more than one robot, the laser welder can alternate from one end effector to the other, with one end effector being displaced while welding is occurring at the other end effector.

In some embodiments, the clamping elements 240a and 240b of the end effector 226 protrude from the second face 236b of the end effector 226. The clamping elements 240a and 240b can form one or more perimeters surrounding either one or both the positive and negative tabs 242a and 242b of the busbar 202 when the end effector 226 is into position. The clamping elements 240a and 240b may be biased against the second face 236b of the body 236 as well, thereby allowing to convey a tightly reproducible force from one battery cell to another. The biasing mechanism can take different forms depending on the embodiment, and can typically involve one or more resilient members. For instance, in the illustrated embodiment, the end effector 226 has a first coil spring having a first hollow end mounted to the second face and surrounding the first laser aperture and an opposite second hollow end spaced apart from the first hollow end. As shown, the second hollow end of the coil spring includes one or more clamping elements. In position, the second hollow end surrounds the positive tab of the busbar and forces it against the underlying positive pole of the battery cell. The end effector also has second coil springs with first hollow ends mounted to the second face and distributed around the second laser aperture, and opposite second hollow ends spaced apart from the first hollow ends. As shown, the second hollows ends of the second coil springs include one or more clamping elements. As such, when the end effector is moved vertically downwards, the clamping elements can be biasingly engaged with the surroundings of the negative tabs of the busbar. Other types of coils or biasing mechanisms can be used in other embodiments.

In some embodiments, the robot arm may be configured for moving the end effector 226 solely within a plane parallel to the busbar 202, whereas the second end of the robot arm can have a distinct actuator configured for moving the end effector 226 across the plane (i.e., along the Z-axis) of the busbar 202, whereas in other embodiments, the robot arm can be responsible for moving the end effector 226 freely in the three dimensions.

In some embodiments, the second end of the robot arm can have a distinct actuator configured for rotating the end effector 226 about an axis normal to the plane of the busbar 202 (i.e., around the Z-axis). Such a latter actuator can help ensuring that the first and second laser apertures 238a and 238b of the end effector 226 are aligned with corresponding tabs 242a and 242b of the busbar 202, which can be relevant, for instance, when the robot arm has a member which pivots in the X/Y plane. In some embodiments, the actuator is rotatably mounted to the second end and/or to the end effector using a bearing having a centre laser aperture through which the laser beam can be directed.

In one embodiment, moving can further include rotating the end effector about an axis normal to the plane of the busbar to ensure the laser aperture suitably exposes the pair of positive and negative tabs of the busbar across corresponding ones of the laser apertures. The rotating can be performed during the transversal movement 250a, during the vertically downwards movement 250b and 250c or sequentially after either one of the movement steps, depending on the embodiment.

FIG. 4 is a graph 400 showing two consecutive welding sequences 452 which can be performed by the system of FIG. 2. As shown, the first robot arm moves laterally during a first period of time t1, then moves vertically downwards for a second period of time t2, after which it is held into position for a third period of time t3. The laser-welding system is activated during the third period of time t3 to perform the required weld lines. The first robot arm is then moved vertically upwards for a fourth period of time t4. The welding sequence can be performed a number of times until all the pairs of positive and negative tabs of the busbar are suitably welded to corresponding poles of the battery cells. In one example embodiment, the first, second and fourth periods of time t1, t2 and t4 each amounts for 60 ms while the third period of time t3 lasts only 20 ms, i.e., the time required for the laser-welding system to perform two weld lines, with the laser-welding system being activated only ˜11% of the whole time associated to a given instance of a welding sequence. In another embodiment, the first, second and fourth periods of time t1, t2 and t4 each amounts for 50 ms while the third period of time t3 lasts only 15 ms. As can be noted, in this example, the time of the whole welding sequence is strongly affected by the movement of the first robot arm, which suggests that reducing the footprint, and overall weight of the end effector can in turn favourably impact the total time of the welding sequence, for a given robot.

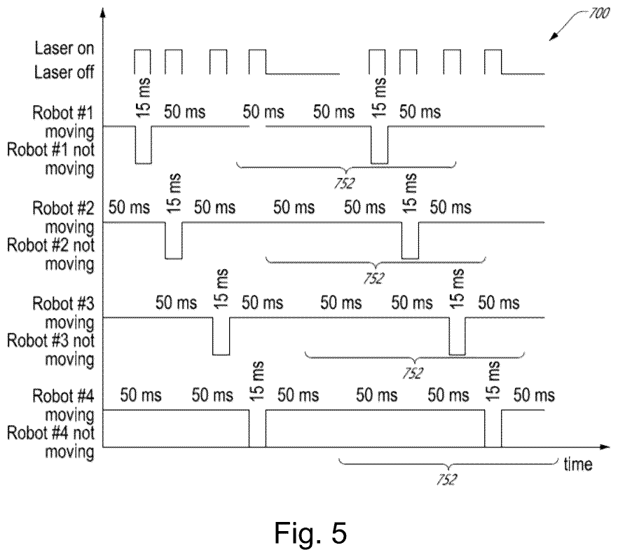

In some embodiments, more than one robot or robot arm can be provided. FIG. 5 shows a graph 700 showing the states of an exemplary laser-welding system having four robot arms, showing the sates of the robot arms during consecutive welding sequences 752. As shown, each of the robot arms is performing a similar welding sequence 752 but delayed from one another. Accordingly, this can allow the laser-welding system to be activated four times as much during a single welding sequence, which can reduce the amount of time required to laser weld all the battery cells of a module. In some embodiments, only one first robot arm can be sufficient. In some other embodiments, two or more first robot arms can be used to proportionally optimize the laser-welding sequences and overall throughput.

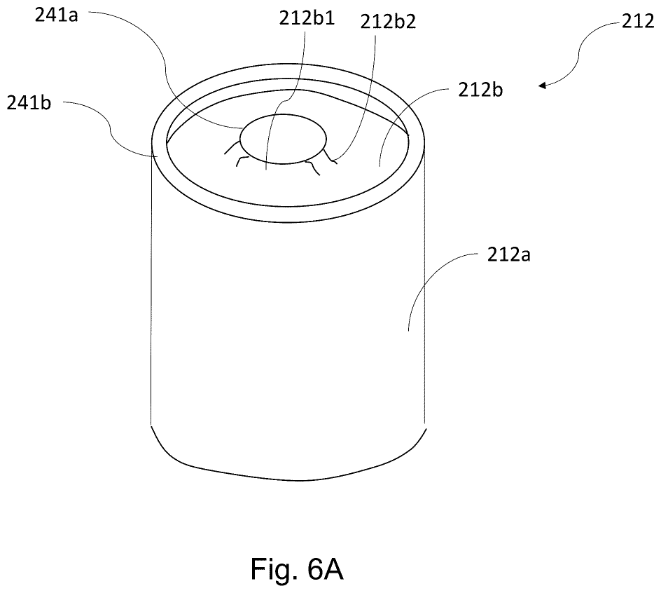

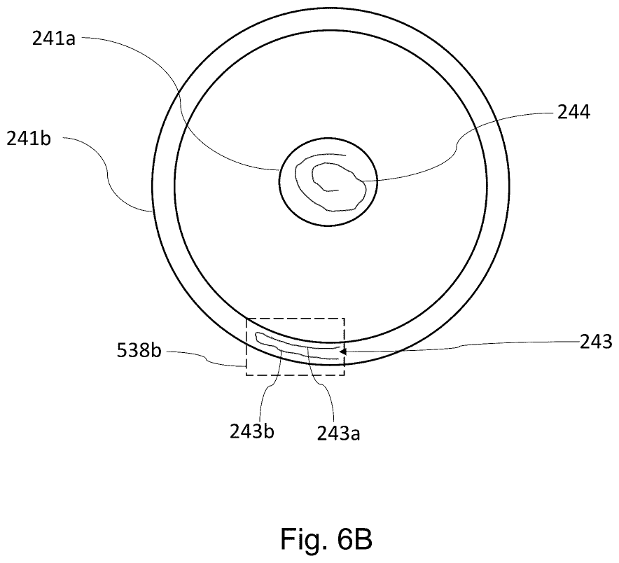

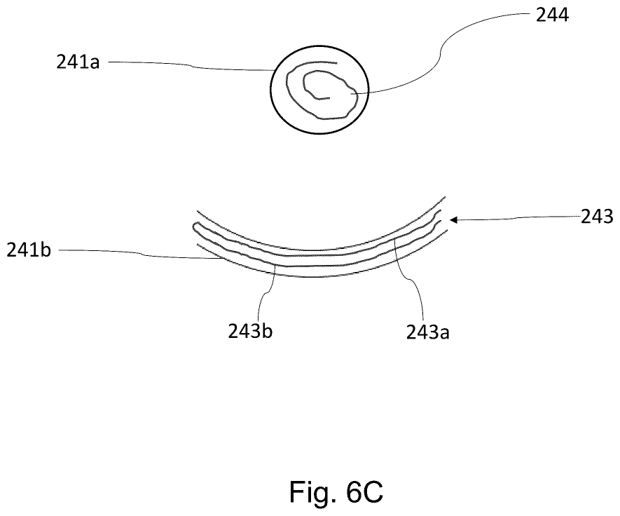

Referring now to FIGS. 6A-6C, an example battery cell 212 is shown. In this example, the battery cell, which may be a 21700 format battery cell for example, generally has a cylindrical shape, and the positive pole 241a and the negative pole 241b are on the same side, but it will be understood that other battery cells may have other shapes or configurations, such as having the positive pole and the negative pole on opposite sides. In some cases, the physical configuration of the battery cell 212 may pose a risk of overheating (i.e., exceeding the battery's thermal requirements) during the welding process. For instance, a typical welding procedure may involve forming a first weld path 243 on the negative pole 241b (through second aperture 538b, illustratively shown as a rectangle for simplicity), and then forming a second weld path 244 on the positive pole 241a (through the first laser aperture 538a), which complete the welding of the busbar to that specific battery cell. The negative pole 241b is annularly shaped with a narrow width. As such, the first weld path 243 may be formed of two weld lines 243a, 243b along respective edges of the negative pole 241b to ensure sufficient weld strength. FIGS. 6B and 6C illustrate an example of the two weld lines 243a, 243b having been performed sequentially (demonstrated by the curved portion joining the two weld lines 243a, 243b) before the second weld path 244 is performed, which each battery cell 212 being fully welded before moving onto a next battery cell 212. Due to the limited space for the weld path due to the small size of the second aperture 538b, performing the two weld lines 243a, 243b sequentially may lead to overheating. In the shown case, the depicted battery cell 212, having peripheral surface 212a and top surface 212b, the positive pole 241a may be less sensitive to temperature related concerns than the negative pole 241b, for instance due to the increased space afforded by the first aperture 538b as well as due to a gap 212b1 created between legs 212b2 supporting the positive pole 241a, for instance. This is but one possible example of an area on a battery cell which may make it difficult or unsuitable to perform a weld in a continuous segment without exceeding a temperature specification of the battery cell.

In one embodiment, an idle pause or delay may be introduced between the performing of the two weld lines 243a, 243b, allowing the negative pole 241b to sufficiently cool to avoid overheating. However, these delays may be undesirable as they may slow down the overall welding process, reducing the overall efficiency of the system. For instance, in an embodiment such as shown with reference to FIG. 4, the “laser on” period is shown to only require 15 ms. However, if a pause is required in each “laser on” period, the overall process will increase in required time with each subsequent “laser on” period. Indeed, with reference to an exemplary welding procedure with four distinct robots, the delays may accumulate, with each subsequent “laser on” period requiring more time to accommodate a cool down period for each negative pole 241b. Therefore, it may be advantageous to perform the two weld lines 243a, 243b separately (i.e., non-sequentially so that the negative pole 241b may have time to cool) in a manner that maximizes efficiency such that the welding procedure may be performed as quickly as possible, while minimizing the likelihood of the negative pole 241b overheating.

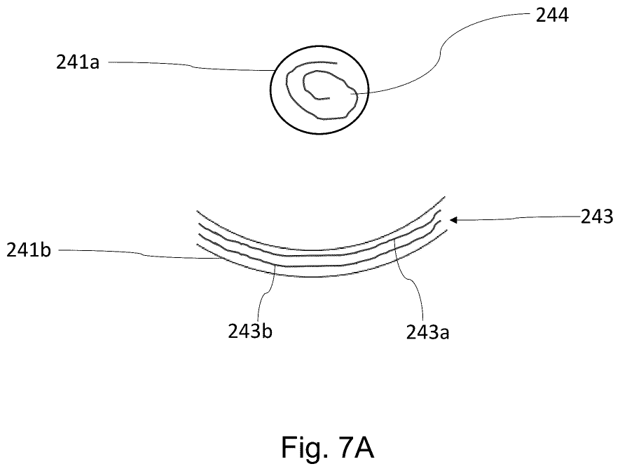

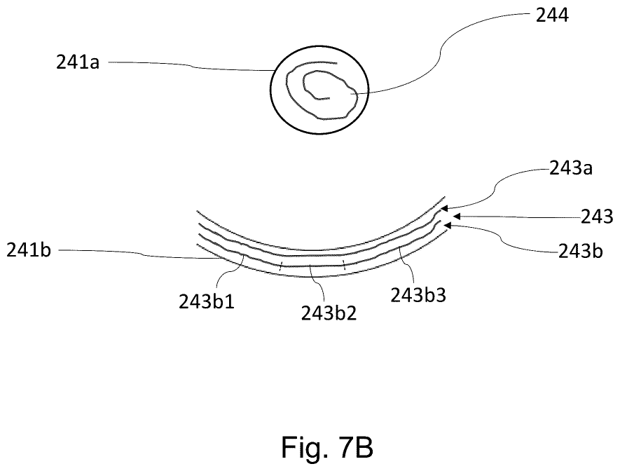

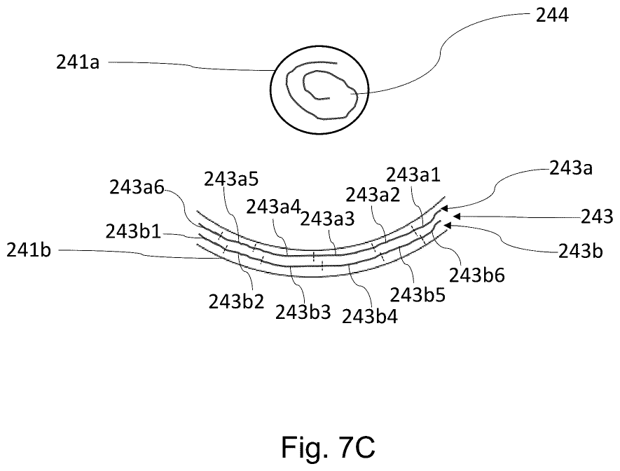

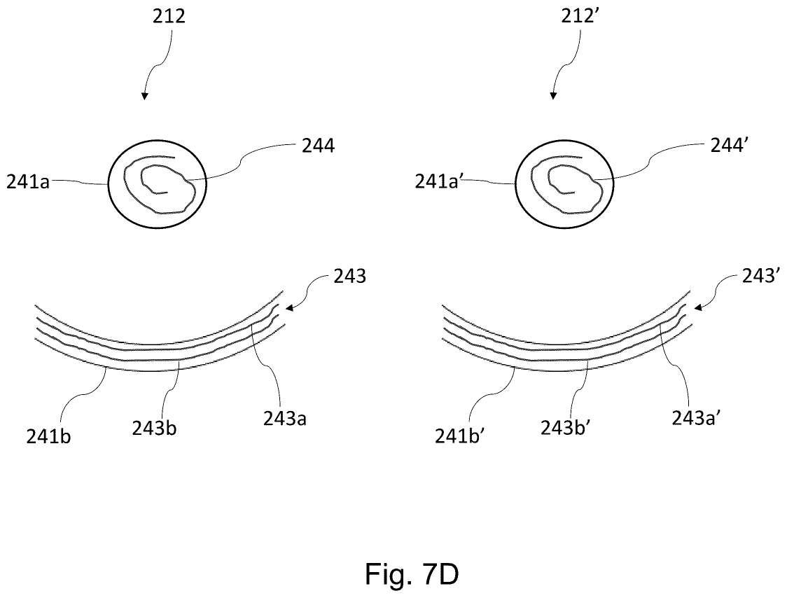

Various welding paths may be contemplated to perform the first weld path 243 in multiple steps (or segments) while maximizing efficiency. Referring to FIG. 7A, in an example embodiment, each battery cell 212 is fully welded before proceeding to the next battery cell 212. As a first step, the negative pole 241b is partially welded (e.g., weld line 243a, along a first welding path segment, is performed). Next, a welding path segment 244 on the positive pole 241a is performed, thereby allowing the negative pole 241 to cool down. Then, the welding of the negative pole 241b is completed (e.g., weld line 244b, along a third weld path segment, is performed) before applying the laser welding to a next battery cell 212. Stated differently, in this embodiment, each battery cell 212 is fully welded before proceeding to the next, with the welding of the positive pole 241a (weld path 244) performed between two distinct weld lines 243a, 243b performed on the negative pole 241b. In some cases, each one of the three steps may be performed while a given clamping element 240 is applying pressure to the corresponding tabs and poles. In some other cases, the first two steps (i.e., weld lines 243a, 244) may be performed while a given clamping element 240 is applying pressure, and the final step (i.e., weld line 243b) may be performed when the clamping element 240 is no longer applying pressure.

Referring to FIG. 7B, another example embodiment is shown. As was the case in the embodiment of FIG. 7A, each battery cell 212 is fully welded before proceeding to the next, with the welding of the positive pole 241a along a corresponding welding path segment performed between two distinct welding path segments performed on the negative pole 241b. However, in the embodiment of FIG. 7B, as a first step, the negative pole 241b is partially welded by way of one or more spot welds, to be completed at a later stage. Illustratively, as a first step, the first weld line 243a is welded completely, and the second weld line is spot welded (e.g., only welding path segment 243b2 is welded), i.e., not welded completely. Next, a weld path segment 244 on the positive pole 241a is performed, during which the negative pole 241 cools down. Then, the welding of the negative pole 241b is completed by performing weld lines at the remaining weld path segments (e.g., segments 243b1 and 243b3) before proceeding to a next battery cell 212. Stated differently, in this embodiment, each battery cell 212 is fully welded before proceeding to the next, with the welding of the positive pole 241a (weld path 244) performed between two distinct welding procedures performed on the negative pole 241b. In the first step, the negative pole 241b is only partially welded, with the second weld line 243b to a degree providing sufficient strength, with the remainder of the second weld line 243b ulteriorly completed after the negative pole 241b has had sufficient time to cool. In some cases, each one of the three steps may be performed while a given clamping element 240 has been continuously applying pressure to the corresponding tabs and electric poles. In some other cases, however, the first two steps may be performed while a given clamping element 240 has been continuously applying pressure to the corresponding tabs and electric poles, but the final steps, or welding path segments, may be performed when the clamping element 240 is no longer applying pressure, such as by being performed once the clamping element 240 has been moved onto a different battery cell, and optionally even when additional, intermediary welding path segments, have been performed on the additional battery cells. In some cases, such example embodiments of a weld procedure may be performed in cases where two or more robots are present.

Another embodiment of the above-described spot welding embodiment is shown in FIG. 7C. As was the case in the embodiment of FIGS. 7A and 7B, each battery cell 212 is fully welded before proceeding to the next, with the welding of the positive pole 241a performed between two distinct weld procedures performed on the negative pole 241b. As was the case in the embodiment shown in FIG. 7B, in the embodiment of FIG. 7C, as a first step, the negative pole 241b is partially welded by way of spot welds. Illustratively, spots or segments of the first weld line 243a (e.g., segments 243a1, 243a3, 243a5) and spots or segments of the second weld line 243b (e.g., segments 243b1, 243b3, 243b5) are performed, providing sufficient strength to the first weld path 243 without overheating the negative pole 241b. Next, a weld path 244 on the positive pole 241a is performed, thereby allowing the negative pole 241 to cool down. Then, the welding of the negative pole 241b is completed by performing weld lines at the remaining segments before proceeding to a next battery cell 212. Illustratively, the remaining spots or segments of the first weld line 243a (e.g., segments 243a2, 243a4, 243a6) and the remaining spots or segments of the second weld line 243b (e.g., segments 243b2, 243b4, 243b6) are performed. Stated differently, in this embodiment, each battery cell 212 is fully welded before proceeding to the next, with the welding of the positive pole 241a (weld path 244) performed between two distinct spot welding procedures performed on the negative pole 241b. In some cases, the first two steps may be performed while a given clamping element 240 is applying pressure, and the final step may be performed when the clamping element 240 is no longer applying pressure. In some cases, this example embodiment of a weld procedure may be advantageously performed in cases where two or more robots are present. Other embodiments of this spot-welding method may be contemplated.

Referring to FIG. 7D, in another example embodiment, welds may be partially completed on two or more battery cells 212 before returning to complete the welds. While FIG. 7D illustratively depicts two battery cells 212, 212′, it is understood that the following methodology is applicable to arrangements of a plurality of battery cells. As a first step, the negative pole 241b is partially welded (e.g., weld line 243a is performed along a first welding path segment) on the first battery cell 212. Next, a welding path segment 244 on the positive pole 241a of the first battery cell 212 is performed. The laser then moves to the second battery cell 212′ to carry out a similar welding procedure (i.e., weld path segments 243a′ and 244′). The laser may then optionally move on to additional battery cells 212 (not shown). Once more than one battery cell 212 has been partially welded as described above, the laser may then move back to the first battery cell 212 to complete the welding procedure (i.e., weld line 243b), then to the second battery cell 212′ to produce weld line 243b, and the same for any subsequent battery cells 212, during which latter steps the corresponding poles may or may not be clamped to the corresponding tabs. Accordingly, in one embodiment, each battery cell 212 may be partially welded (i.e., only a portion of the negative pole 241b is welded) while being clamped, before unclamping and proceeding to the next, and after all cells 212 are partially welded, the laser may return to each cell 212 to complete the welding of the negative poles 241. In some cases, the partial welds may be performed while a given clamping element 240 is clamping, and the final step (i.e., completing the welds of the negative poles 241) may be performed when the clamping element 240 is no longer clamping.

Various modifications and combinations of the above-described welding procedures may be contemplated. For instance, in the embodiment shown in FIG. 7D, rather than performing weld lines 243a, 244 on each battery cell 212 before returning to complete weld line 243b on each cell, the partial welding of each battery cell 212 may include spot welding the negative pole 241b (as was the case in the embodiment shown in FIG. 7C) and welding the positive pole 241a of each cell before returning to weld the remaining segments of the negative pole 241b. In addition, the clamping of the various tabs and poles may vary. In some embodiments, both the positive and negative poles 241a, 241b of a single battery cell 212 may be clamped simultaneously. In other embodiments, the positive and negative poles of two adjacent battery cells 212 may be clamped simultaneously. In other embodiments, only one pole (e.g., one of the positive and negative poles 241a, 241b) of a single battery cell 212 may be clamped at a time, for instance in a case where a first weld segment is performed on a first clamped pole, before the clamping is shifted to a second pole where a second weld segment is performed. As noted above, in some cases, partial welds (e.g., spot welds) may be performed at tabs of multiple battery cells sequentially before returning to complete the welds. In various cases, clamping may or may not be performed between a pole and a corresponding tab when welding is to occur. In cases where clamping is not performed, the overall process may be completed in a more timely manner.

More generally, the first welding path segment and second welding path segment may concern different poles of a same battery, a same pole of a same battery, a same pole of different batteries, or different poles of different batteries. The third welding path segment comes back to the same pole that was welded along the first welding path segment. Typically, first welding path segment and second welding path segment will be performed when the corresponding pole and tab are clamped to one another, but there may be scenarios where the first welding path segment, the second welding path segment, or both, may be performed when the corresponding pole and tab are not clamped to one another, such as in scenarios where they have previously been spotwelded to one another. The third welding path segment may be performed when the corresponding pole and tab are clamped or unclamped to one another. For instance, the performing of the first welding path segment may amount to spotwelding the corresponding pole to the corresponding tab, which may sufficiently hold the corresponding pole against the corresponding tab in some embodiments so as to allow the releasing of the clamping of the corresponding pole and tab between the performing of the first welding path segment and the third welding path segment. There may be additional welding path segments between the first and the second welding path segments, and/or between the second and the third welding path segments. Other modifications and combinations may be contemplated.

While FIG. 7D illustratively shows two battery cells 212, 212′ in a battery module, it is understood that battery modules may include a larger number of battery cells 212. In such cases, the embodiment shown in FIG. 7D may be carried out in a number of ways. For instance, the weld lines 243a and 244 may be performed on each battery cell 212 in a given battery module before returning to complete the final weld lines 243b of each cell. Alternatively, the weld lines 243a and 244 may be performed on a subset of the cells 212 in a module (e.g., two cells 212 sequentially) before completing the final weld lines 243b of this subset of cells 212 before proceeding to a next subset of cells 212. Other modifications to the above-described methodology may be contemplated.

In each of the above-described embodiments, a welding pathway susceptible to overheating (e.g., the negative pole of a 21700 format battery cell) is broken down into distinct, non-sequential steps to allow time to cool while one or more other welding steps are performed to maximize efficiency. In some cases, additional pauses between steps may be contemplated to allow for further cooling.

An exemplary battery module according to an embodiment of the present disclosure is described below. The battery module has a plurality of battery cells 212, each battery cell 212 having a first pole (for instance positive pole 241a) and a second pole (for instance negative pole 241b). The battery module further includes a busbar 202 having a plurality of tabs (for instance, positive and negative tabs 242a, 242b) welded to corresponding ones of the first poles and second poles 241a, 241b. The tabs 242a, 242b are welded to corresponding ones of the first poles 241a along a first weld pattern 243. The tabs 242a, 242b are welded to corresponding ones of the second poles 241b along a second weld pattern 244. The second weld pattern 244 has a second weld segment. The first weld pattern 243 has a first weld segment 243a, a third weld segment 243b, and a discontinuity between the first weld segment 243a and the third weld segment 243b. In some embodiments, the discontinuity may include an unwelded gap between the first weld segment 243a and the third weld segment 243b. In some embodiments, the discontinuity may include a ridge visible to the naked eye between the first weld segment 243a and the third weld segment 243b. In some embodiments, the second weld pattern 244 further has a fourth weld segment and a discontinuity between the second weld segment and the fourth weld segment.

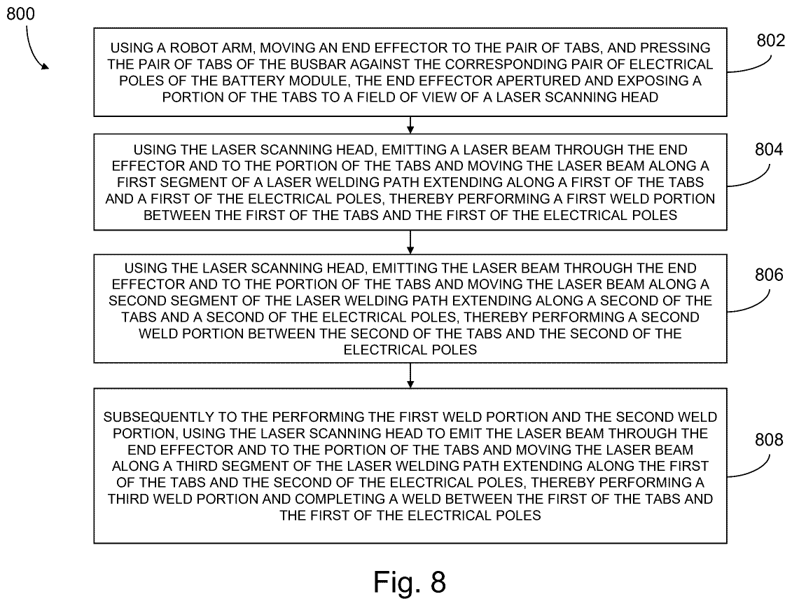

FIG. 8 shows a flow chart of a method 800 for laser-welding a busbar to a battery module with a laser-welding system having a robot arm and a laser scanning head, the busbar having a pair of tabs including a first region positioned over a corresponding pair of electrical poles of the battery module. The method 800 is described with reference to the system of FIG. 2. Although, it is intended that the method 800 can be performed by any other suitable system.

At step 802, an end effector is moved, using the robot arm, to the pair of tabs, and the pair of tabs of the busbar are clamped against the corresponding pair of electrical poles of the battery module, the end effector being apertured and exposing a portion of the tabs to a field of view of the laser scanning head.

At step 804, a laser beam is emitted, using the laser scanning head, through the end effector and to the portion of the tabs, and the laser beam is moved along a first segment of a laser welding path, the first segment of the laser welding path extending along a first tabs and a first of the electrical poles, thereby performing a first weld portion between the first of the tabs and the first of the electrical poles.

At step 806, the laser beam is emitted, using the laser scanning head, through the end effector and to the portion of the tabs, and the laser beam is moved along a second segment of the laser welding path extending along second of the tabs and a second of the electrical poles, thereby performing a second weld portion between the second of the tabs and the second of the electrical poles.

At step 808, subsequently to performing of the first weld portion and the second weld portion, the laser beam is emitted, using the laser scanning head, through the end effector and to the portion of the tabs, and the laser beam is moved along a third segment weld portion and completing a weld between the first of the tabs and the first of the electrical poles.

In some embodiments, the first electrical pole corresponds to the negative pole 241b, while the second electrical pole corresponds to the positive pole 241a. In other embodiments, the opposite may be contemplated. For instance, in some embodiments, the positive pole 241a may be more susceptible to overheating, for instance due to alternate geometry of the battery cell, and may require a non-sequential welding procedure to minimize the risk of overheating while maintaining efficiency. In other cases, both the positive and negative poles 241a, 241b may be susceptible to overheating. In such cases, it may be desirable to perform the welding procedure non-sequentially on both the positive pole 241a and the negative pole. Other variations may be contemplated as well.

In some embodiments, steps 804 and 806 may be performed in any order, with these steps being performed while the robot arm end effector is clamping the busbar against the electrical poles.

In some embodiments, at step 804, performing the first weld portion includes performing a first weld line between the first of the tabs and the first of the electrical poles, and, at step 808, the performing the third weld portion includes performing a second weld line between the first of the tabs and the first of the electrical poles adjacent the first weld line.

In some embodiments, at step 804, the performing the first weld portion includes performing a first weld line between the first of the tabs and the first of the electrical poles and partially performing a second weld line between the first of the tabs and the first of the electrical poles adjacent the first weld line, and at step 808, the performing the third weld portion includes completing the second weld line between the first of the tabs and the first of the electrical poles.

In some embodiments, for instant where the battery module further includes an additional pair of tabs and one or more additional pair of corresponding electrical poles (i.e., of additional battery cell(s)), various additions to the above-described steps may be contemplated. For instance, prior to step 808 at the pair of electrical poles, steps 804 and 806 are completed at one or more of the additional battery cells before returning to the first battery cell for step 808.

Other modifications and additions to the above-described method may be contemplated.

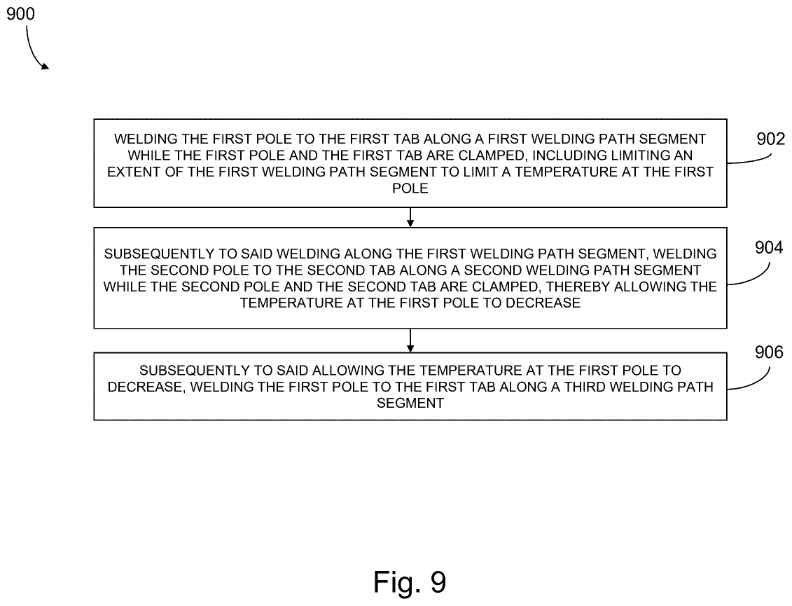

FIG. 9 shows a flow chart of a method 900 for laser-welding a busbar to a plurality of battery cells with a laser-welding system having a laser scanning head, the busbar having a first tab and a second tab, the plurality of battery cells having a first pole and a second pole. The method 900 is described with reference to the system of FIG. 2. Although, it is intended that the method 900 can be performed by any other suitable system.

At step 902, the first pole is welded to the first tab along a first welding path segment while the first pole and the first tab are clamped. An extent of the first welding path is limited to limit a temperature at the first pole.

At step 904, after performing the first welding path segment, the second pole is welded to the second tab along a second welding path segment while the second pole and the second tab are clamped, thereby allowing the temperature at the first pole to decrease.

At step 906, after allowing the temperature at the first pole to decrease, the first pole is welded to the first tab along a third welding path segment.

Various modifications and additions to the above-described method may be contemplated.

In some embodiments, the first pole and the second pole are of a same battery cell of the plurality of battery cells.

In some embodiments, the first pole and said second pole are of different battery cells of the plurality of battery cells.

In some embodiments, the method 900 further includes simultaneously clamping the first pole to the first tab and the second pole to the second tab.

In some embodiments, the method 900 further includes unclamping the first pole from the first tab before or while the welding along the second welding path segment is performed.

In some embodiments, the welding the second pole to the second tab along the second welding path segment is performed immediately subsequently to the welding along the first welding path segment.

In some embodiments, the method 900 further includes, subsequently to the welding along the first welding path segment, and prior to the welding along the second welding path segment, welding along an other welding path segment.

In some embodiments, welding the third welding path segment is performed immediately subsequently to the welding along the second welding path segment.

In some embodiments, the method 900 further includes, subsequently to the welding along the second welding path segment, and prior to the welding along the third welding path segment, welding along an other welding path segment.

In some embodiments, the method 900 further includes repeating the welding along the first welding path segment for each one of the plurality of battery cells, repeating the welding along the second welding path segment for each one of the plurality of battery cells, and wherein the welding along the third welding path segment is performed subsequently to the repeating the welding along the first welding path segment and to the repeating said welding along the second welding path segment.

In some embodiments, the method 900 further includes repeating a sequence of the steps of welding along the first welding path segment, welding along the second welding path segment, and welding along the third welding path segment for a number of iterations corresponding to a number of the plurality of cells, on different ones of the plurality of cells.

In some embodiments, the method further includes unclamping the first pole from the first tab between each repetition of the welding along the first welding path segment, and unclamping the second pole from the second tab between each repetition of the welding along the second welding path segment.

In some embodiments, the plurality of battery cells is a first plurality of battery cells of a battery module, the battery module further includes a second plurality of cells, and the method 900 further includes repeating a sequence of the steps of welding along the first welding path segment, welding along the second welding path segment, and welding along the third welding path segment for the second plurality of cells.

In some embodiments, the method 900 further includes moving the laser scanning head from the first plurality of battery cells to the second plurality of battery cells prior to the repeating the sequence of steps.

In some embodiments, each one of the steps of welding along the first welding path segment, welding along the second welding path segment, and welding along the third welding path segment includes moving a laser beam emitted by the laser scanning head.

In some embodiments, the welding along the third welding path segment allows the temperature at the second pole to decrease, and the method 900 further includes, subsequently to the allowing the temperature at the second pole to decrease, welding the second pole to the second tab along a fourth welding path segment.

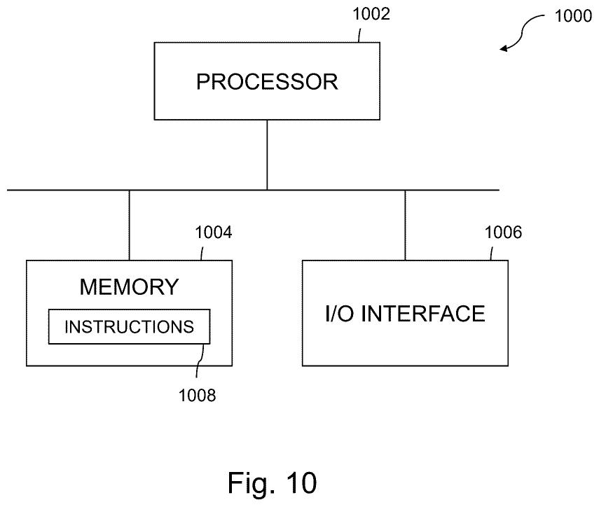

Referring now to FIG. 10, the controller of the system of FIG. 2 can be provided as a combination of hardware and software components. The hardware components can be implemented in the form of a computing device 1000, an example of which is described with reference to FIG. 10. The computing device 1000 can have a processor 1002, a memory 1004, and I/O interface 1006. Instructions 1008 for controlling at least the first and second robot arms and laser-welding system can be stored on the memory 1004 and accessible by the processor 1002.

The processor 1002 can be, for example, a general-purpose microprocessor or microcontroller, a digital signal processing (DSP) processor, an integrated circuit, a field-programmable gate array (FPGA), a reconfigurable processor, a programmable read-only memory (PROM), a programmable logic controller (PLC), or any combination thereof.

The memory 1004 can include a suitable combination of any type of computer-readable memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 1006 enables the computing device 1000 to interconnect with one or more input devices, such as a camera, a pressure sensor, or any other sensor, or with one or more output devices such as robot arm(s), laser-welding system(s). For instance, a pressure sensor or load cell can be mounted to the end effector to measure in real-time the pressure applied by the end effector, or each of its clamping elements, against the busbar.

Each I/O interface 1006 enables the controller to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fibre optics, satellite, mobile, wireless (e.g. Wi-Fi, WiMAX), SS7 signaling network, fixed line, local area network, wide area network, and others, including any combination of these.

The computing device 1000 and any software application that can be ran by the computing device 1000 are meant to be examples only. Other suitable embodiments of the controller can also be provided, as it will be apparent to the skilled reader.

As can be understood, the examples described above and illustrated are intended to be example only. Typically, the battery module remains immobile during the welding sequences. As the battery module is heavy, its movement would not be time or resource efficient. The battery module can be moved between laser-welding sequences at least in some embodiments. Although battery cells of cylindrical shapes have been discussed herein, it is intended that the methods and systems described herein can be used to laser-weld busbar(s) to battery cells of any shape or form including, but not limited to, prismatic battery cells. In some embodiments, the end effector is used to force one or more clamping elements against the busbar. However, in some other embodiments, only one clamping element can be forced against the positive tab of the busbar while only one clamping element can be forced against the negative tab of the busbar. It is noted that having at least two clamping elements forced against at least one or both of the positive tab and negative tab can be preferred. Three clamping elements surrounding the positive tab or the negative tab, with the three clamping elements surrounding the corresponding tab, can be most preferred in some embodiments. In some embodiments, the end effector can have many pairs of first and second laser apertures, each pair exposing the positive and negative tabs of a corresponding battery cells, with corresponding clamping elements. In these embodiments, the rapidity of the laser-welding sequence can be increased as more than one battery cell can be laser-welded to corresponding tabs of the busbar during a single laser-welding sequence. The scope is indicated by the appended claims.

What is claimed is:

1. A method for laser-welding a busbar to a plurality of battery cells with a laser-welding system having a laser scanning head, the busbar having a first tab and a second tab, the plurality of battery cells having a first pole and a second pole, the method comprising:
welding the first pole to the first tab along a first welding path segment while the first pole and the first tab are clamped, including limiting an extent of the first welding path segment to limit a temperature at the first pole;
subsequently to said welding along the first welding path segment, welding the second pole to the second tab along a second welding path segment while the second pole and the second tab are clamped, thereby allowing the temperature at the first pole to decrease; and
subsequently to said allowing the temperature at the first pole to decrease, welding the first pole to the first tab along a third welding path segment.

2. The method of claim 1 wherein said first pole and said second pole are of a same battery cell of the plurality of battery cells.

3. The method of claim 1 wherein said first pole and said second pole are of different battery cells of the plurality of battery cells.

4. The method of claim 1 further comprising simultaneously clamping the first pole to the first tab and the second pole to the second tab.

5. The method of claim 1 further comprising unclamping the first pole from the first tab before or while said welding along the second welding path segment is performed.

6. The method of claim 1 wherein said welding the second pole to the second tab along the second welding path segment is performed immediately subsequently to said welding along the first welding path segment.

7. The method of claim 1 further comprising, subsequently to said welding along the first welding path segment, and prior to said welding along the second welding path segment, welding along an other welding path segment.

8. The method of claim 1 wherein said welding the third welding path segment is performed immediately subsequently to said welding along the second welding path segment.

9. The method of claim 1 further comprising, subsequently to said welding along the second welding path segment, and prior to said welding along the third welding path segment, welding along an other welding path segment.

10. The method of claim 1 further comprising repeating said welding along the first welding path segment for each one of the plurality of battery cells; repeating said welding along the second welding path segment for each one of the plurality of battery cells; and wherein said welding along the third welding path segment is performed subsequently to said repeating said welding along the first welding path segment and to said repeating said welding along the second welding path segment.

11. The method of claim 1 further comprising repeating a sequence of the steps of welding along the first welding path segment, welding along the second welding path segment, and welding along the third welding path segment for a number of iterations corresponding to a number of the plurality of cells, on different ones of the plurality of cells.

12. The method of claim 10 further comprising unclamping the first pole from the first tab between each repetition of said welding along the first welding path segment, and unclamping the second pole from the second tab between each repetition of said welding along the second welding path segment.

13. The method of claim 1 wherein the plurality of battery cells is a first plurality of battery cells of a battery module, the battery module further comprising a second plurality of cells, further comprising repeating a sequence of the steps of welding along the first welding path segment, welding along the second welding path segment, and welding along the third welding path segment for the second plurality of cells.

14. The method of claim 13 further comprising moving the laser scanning head from the first plurality of battery cells to the second plurality of battery cells prior to said repeating the sequence of steps.

15. The method of claim 1 wherein each one of said steps of welding along the first welding path segment, welding along the second welding path segment, and welding along the third welding path segment includes moving a laser beam emitted by the laser scanning head.

16. The method of claim 1 wherein said welding along the third welding path segment allows the temperature at the second pole to decrease, further comprising, subsequently to said allowing the temperature at the second pole to decrease, welding the second pole to the second tab along a fourth welding path segment.

17. A battery module having a plurality of battery cells, each battery cell of the plurality of battery cells having a first pole and a second pole, and a busbar having a plurality of tabs welded to corresponding ones of the first poles and second poles, the plurality of tabs being welded to corresponding ones of the first poles along a first weld pattern, the plurality of tabs being welded to corresponding ones of the second poles along a second weld pattern, the second weld pattern having a second weld segment, the first weld pattern having a first weld segment, a third weld segment, and a discontinuity between the first weld segment and the third weld segment.

18. The battery module of claim 17 wherein the discontinuity includes an unwelded gap between the first weld segment and the third weld segment.

19. The battery module of claim 17 wherein the discontinuity includes a ridge visible to the naked eye between the first weld segment and the third weld segment.

20. The battery module of claim 17 wherein the second weld pattern further has a fourth weld segment, and a discontinuity between the second weld segment and the fourth weld segment.
